(19) United States
(12) Patent Application Publication
(10) Pub. No.: US 2007/0190384 A1
(43) Pub. Date: Aug. 16, 2007

(54) Proton conductive membrane containing fullerenes

(76) Inventors: Ken Tasaki, Goleta, CA (US); Jeffrey Gasa, Goleta, CA (US); Ryan Desousa, Goleta, CA (US); Hengbin Wang, Goleta, CA (US)

Correspondence Address: CISLO & THOMAS, LLP, 233 WILSHIRE BLVD, SUITE 900, SANTA MONICA, CA, 90401-1211, US

(21) Appl. No.: 11/357,655

(22) Filed: Feb. 16, 2006

(51) Int. Cl. H01M 8/10; C08J 5/22

(52) U.S. Cl. 429/33; 521/27

(57) ABSTRACT

A proton conducting membrane for use in a direct methanol fuel cell, comprising a polymer material and water-binding fullerene derivatives to reduce MeOH crossover. The membrane may further comprise cross-linking functional groups.

### TECHNICAL FIELD

This invention relates to electrolytic membranes used in direct methanol fuel cells and methods to produce such membranes, and more particularly to cross-linked proton conducting membranes including water-binding fullerenes.

### BACKGROUND ART

Direct methanol fuel cells (DMFC) are increasingly important, becoming a choice for fuel cells for portable applications such as batteries for laptop computers and cell phones. Unlike H₂PEFC in which hydrogen is fed to the anode, DMFC uses liquid methanol as the fuel. At the anode, methyl alcohol (MeOH) is oxidized in the presence of water. This oxidation generates electrons to power the circuit, hydrogen ions that travel through the electrolytic membrane of the fuel cell, and carbon dioxide as a by-product. At the cathode, the hydrogen ions react with oxygen and electrons from the circuit producing water as the only other by-product.

One of the most serious technical hurdles in development of DMFC is the MeOH permeation through a membrane, otherwise known as “the methanol crossover.” Inefficiencies arise since the methanol crossover (i) reduces the power when methanol reaches at the cathode to be oxidized by the oxygen, (ii) loses the fuel, thus decreasing the fuel efficiency, (iii) enlarges unnecessarily the dimension of the fuel cell since using a high concentration of methanol results in more methanol crossover, thus resorting to lower concentrations which thus require a larger fuel storage, and (iv) makes it difficult to operate at high temperatures which increases the catalytic activity, but in turn promotes more methanol permeation. Most membranes that are used in DMFC employ water as the principal proton conducting medium, and efforts to block methanol while allowing water to freely permeate the membrane have turned out to be extremely difficult. Most efforts to reduce methanol crossover come at the expense of the proton conductivity.

The higher the equivalent weight (EW) of the membrane, the higher the water drag coefficient, thus more water will permeate through the membrane. There is a linear correlation between the water drag coefficient and the methanol crossover. Hence, one way to reduce the methanol crossover is to use membranes with high EW, such as, for example, by reducing the degree of sulfonation to the polymer. This approach, however, also usually reduces the proton conductivity.

The methanol crossover can also be reduced by employing thicker membranes. However, thicker membranes also result in higher ohmic resistance when assembled in a fuel cell. Another approach would be to use methanol impermeable polymers as the membrane, such as, for example, poly(phosphazine). Yet, again, the cell performance also decreases as the methanol crossover is reduced. Still another approach has been to use inorganic fillers such as SiO₂ or TiO₂. This is effective in reducing the MeOH crossover, but it often leads to increasing the membrane resistance.

It has been also found that cross-linking of a proton conducting membrane is effective in reducing the MeOH crossover. However, cross-linking of a membrane through chemical bonds tends to cause membrane stiffness and brittleness as well as increase the membrane resistance.

### DISCLOSURE OF INVENTION

Upon investigating the relationship between the state of water in proton conducting membranes and their MeOH crossover, there appears to be a correlation between the amount of free water in the membrane and the MeOH crossover. In the present invention, it has been determined that some fullerene derivatives can bind water molecules. These fullerene derivatives, when mixed in a host polymer or when chemically attached to the polymer, exhibit very small quantities of free water, and contrary to other approaches, increasing the fullerene content in the polymer reduces the MeOH crossover while in fact maintaining the high proton conductivity.

The present invention, therefore, is directed to a proton conducting membrane for use in a direct methanol fuel cell, where the membrane comprises a polymer material and water-binding fullerene derivatives. The polymer can be any polymer and can be MeOH permeable so long as the polymer is proton conductive. The membrane may further comprise cross-linking functional groups to further reduce the MeOH crossover.

Fullerenes with functional groups such as amino groups (—NH₂) interact strongly with the acid groups of a proton conducting membrane through acid-base interactions, thus forming an ionic cross-link with the polymer. Ionic cross-linking gives rise to a more flexible, less brittle membrane, compared to chemically cross-linked membranes. The membrane may further comprise cross-linking fullerenes to further reduce the MeOH crossover.

### BRIEF DESCRIPTION OF DRAWINGS

FIG. 1 is a schematic of an embodiment of a proton conductive membrane showing a cross-over.

FIG. 2 shows polarization curves of 3 wt % C₆₀(OH)ₙ-Nafion composite and recast Nafion membrane according to an embodiment of a proton conductive membrane containing fullerenes.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

A first aspect of the present invention is to use in the proton conducting membrane of a direct methanol fuel cell those fullerene derivatives that hold a large amount of bound water, referred to as “water-binding fullerenes.” Water-binding fullerenes are those fullerenes chemically attached by functional groups, including C₆₀ (with no functional group) itself, where the functional groups strongly bind water molecules to themselves. The water binding by the functional groups appears to be primarily due to the electron transfer between the water molecule and the functional group, such as hydrogen bonds, which are caused by either hydrogen acceptance or hydrogen donation by the functional group. Thus, those functional groups with either a hydrogen acceptor or a hydrogen donor are good candidates for the invention. Thus, one embodiment of the present invention involves increasing the efficiency of water-binding agents by attaching the functional groups to fullerene, which reduces MeOH crossover.

Fullerenes can have the functional groups in a large surface density as well as in an extremely high volumetric density. The present invention takes advantage of this unique property of fullerenes to maximize the effect by the water-binding functional groups. The inventors have demonstrated this effect using, among other agents, polyhydroxy fullerene C₆₀(OH)ₙ, where n is within the range of more than 2 and less than 60, or more preferably, more than 2 and less than 48. Some of the examples discussed below involve C₆₀(OH)₁₂. Polyhydroxy fullerene (referred herein as PHF) was synthesized according to methods known in the art (e.g., Long Y. Chiang, et al., Efficient Synthesis of Polyhydroxylated Fullerene Derivatives via Hydrolysis of Polycyclosulfated Precursors, 59 J. Org. Chem. 3960 (1994)) through sulfonation of C₆₀ and subsequent hydrolysis.

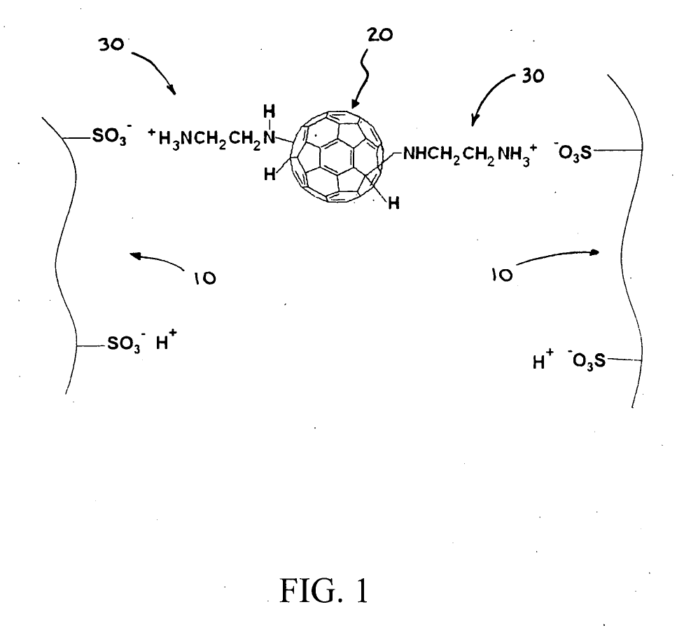

A second aspect of the present invention is based on cross-linking of proton conducting membranes (PCM) to reduce MeOH crossover, an example of which is given in FIG. 1. Cross-linking PCM 20 tends to reduce pores, reducing the possible paths for methanol to permeate through the membrane 10. Fullerene derivatives with multiple cross-linking functional groups, such as the amino groups, more effectively cross-link PCM. The multiple functional groups may cross-link with multiple sulfonic groups of the PCM, for example, per a fullerene derivative, compared to conventional cross-linkers which may cross-link only two sulfonic groups at a time. Furthermore, water-binding groups can also be attached to the fullerene cross-linkers 30 to further reduce the MeOH crossover. The inventors have demonstrated the effectiveness of using base groups as fullerene cross-linkers, such as, for example, aminofullerenes.

Aminofullerene, C₆₀[NH(CH₂)ₙNH₂]ₘ, where 1<n<50 and 2<m<60, was synthesized as follows: a gram of fullerene was added to 50 mL of freshly distilled ethylenediamine to form a solution. The fullerene dissolved in ethylenediamine and formed a dark solution. The dissolution of the hydrophobic fullerene in a hydrophilic solvent such as ethylenediamine was a strong indication that a reaction (neuclophilic addition) took place. Excess ethylenediamine was removed using a rotary evaporator, such as the Rotavapor®, which is commercially available from BUCHI Laboratory Equipment (BÜCHI Labortechnik AG), Switzerland. The product was a black solid, which was insoluble in water but was soluble in ethylenediamine. Based on elemental analysis, an average of five ethylenediamine molecules were attached to each molecule of fullerene.

The preparation of the solution cast fullerene-Nafion® composites was as follows: a 5% Nafion® solution was dried at 80° C. overnight. Since the present invention reduces MeOH crossover, the membrane may be any number of substrates, including even MeOH permeable polymers. Nafion® currently is the industry standard membrane for fuel cells generally, but alone Nafion® is highly methanol permeable and therefore previously of limited use in DMFC. It is a copolymer of tetrafluoroethylene and perfluoro-3,6-dioxa-4-methyl-7-octenesulfonyl fluoride and is commercially available from DuPont in either acid or ionomer form. More broadly, other perfluoro polymer sulfonic acids may be used as well. For the composites used in the present research, the dried Nafion® film was dissolved in dimethylacetamine (DMAc). This Nafion®-DMAc solution, was stirred for several hours and cast on a glass substrate. The film was dried at 120° C. overnight and then annealed at 170° C. (referred herein as Recast Nafion®). Subsequently, a predetermined amount of C₆₀ was dissolved in o-dichlorobenzene, and the solution was added to the Nafion®-DMAc solution while stirring. The solution was cast on a glass substrate and dried overnight. Then, the cast membrane was annealed at 170° C. (to be referred to as C₆₀-Nafion®). The weight percentage (wt %) of C₆₀ in Nafion® was 1%. Separately, PHF was dissolved in DMAc, which was added to the Nafion®-DMAc solution. The mixed solution was cast on a glass substrate and dried in an oven at 120° C. overnight, followed by annealing at 170° C. (to be denoted as, e.g., PHF-Nafion®). The weight percentage of PHF is preferably less than about 20%, more preferably less than about 5%, and most preferably within the range of about 1% to 3%.

To prepare a composite membrane with 1% loading of amino-fullerene, 75.8 mg of amino-fullerene was dissolved in 1 mL of ethylenediamine to form a solution. The solution of amino-fullerene was then mixed with a solution of 750 mg of Nafion® in 10 mL of DMAc. The mixture was cast onto a Teflon® dish at 80° C. for 12 hours to form a membrane with thickness of about 0.1 mm. The membrane was acidified in 1 M H₂SO₄ at 80° C. for one hour. The ion-exchange capacity (IEC) of the composite membrane was much lower than expected, due to residual solvent in the membrane. Thus, it was re-acidified in a more acidic medium (3 M H₂SO₄) and at a longer time (8 hours). The solvent was completely removed after 2 cycles of re-acidification, as judged by the transparency of the acid solution used to wash the membrane. After re-acidification, the membrane was washed repeatedly in de-ionized water at 80° C. for 8 hours until the pH of the water was neutral. The weight percentage of amino-fullerene is preferably less than about 60%, more preferably less than about 20%, and most preferably between about 1% and 5%.

The membrane was pretreated as follows. Nafion® (117 or 115 as needed) was cut to required sizes and stirred in 3 vol % H₂O₂ solution at 90° C. for one hour. The as-received membrane was yellowish-brown in color. The treated membrane was stirred in distilled water for about one hour. After peroxide treatment, the membrane was completely colorless. The cut membrane was then stirred in 0.1M H₂SO₄ at 90° C. for one hour. The cut membrane was further stirred in distilled water for 1 hour to remove the excess acid. The treated clear membrane was stored in distilled water till use. Before making the membrane electrode assembly (MEA), the membrane was patted dry and allowed to air dry for about an hour.

The electrode was then prepared as follows. The electrode was purchased from E-TEK, and then punched out using 0.75-inch diameter punch (resulting in an area of approximately 2.85 cm²). Six to eight drops of diluted Nafion® solution (2:1 by volume Methanol:5% Nafion® solution in Isopropanol [from Aldrich]) were added on the catalyst side ensuring complete coverage. The electrodes were dried in an oven at 70° C. for about 30 minutes. Iron heating-blocks were then stacked on one another with the thermocouple in between them and preheated on a hot-plate to a temperature of 125° C.

The MEA was assembled as follows. A 150 micron Teflon coated fiber-glass tape gasket (TFG) was placed flat and a 250 micron TFG gasket was placed on top. One electrode was placed with the catalyst side up and the Nafion® membrane was placed on top. The second electrode was placed with the catalyst side down making sure that the electrodes were exactly aligned. A 250 micron TFG gasket was placed on top of the sandwich, aligned with the bottom gaskets. Finally, a 150 micron gasket was placed at the top, aligned with the rest of the gaskets.

After the blocks reach the desired temperature, the top block was lifted and the thermocouple removed. The MEA assembly was immediately placed on the bottom block and the top block was carefully placed on the MEA assembly. The hot blocks were transferred to the press, and the shield was closed. The press was pumped up rapidly until the plates contact each other, then gradually ramped to a load of 1200 lb-f. Once at 1200 lb-f, the load was maintained for 90 seconds. Then, the pressure was released by turning the release knob about 45 to 60 degrees counterclockwise until the plates were separated. The MEA was immediately taken off the blocks and allowed to gradually cool.

To measure the water uptake, the membranes were first vacuum-dried at 100° C. overnight and weighed afterward, and then immersed in deionized water at room temperature for 24 hours. The wet water uptake was determined by the following equation:

$$Wet water uptake = \frac{{W}_{wet} - {W}_{dry}}{{W}_{dry}}$$

where W_{wet} and W_{dry} are the weights of the wet and the dry membranes, respectively.

Subsequently, the membranes were equilibrated under 25% relative humidity (RH) overnight and weighed afterward as W_{25%}. Dry water uptake was estimated from the following equation:

$$Dry water uptake = \frac{{W}_{25 \%} - {W}_{dry}}{{W}_{dry}}$$

After all samples were equilibrated in water for 24 hrs, they were blotted on the surface before the measurement. Then, the sample was subject to dry N₂ gas for 40 minutes at 30° C. and the weight loss was monitored. A Mettler Toledo TGA/SDTA 851e was used for the TGA measurements without heating.

MeOH crossover measurements were conducted by measuring the limiting current density for each membrane, using methods known in the art (e.g., Xiaoming Ren et al., Methanol Transport Through Nation Membranes: Electro-osmotic Drag Effects on Potential Step Measurements, 147 J. Electrochem. Soc. 466 (2000)). The cell was assembled using the platinum loading of 0.5 mg cm⁻² and Nafion® loading of 0.8 mg cm⁻² for the electrodes and the composite membrane dispersed by the water-binding fullerene. The anode catalyst was Pt/Ru, while the cathode used Pt only.

AC impedance measurements were performed for the films at 20° C. in the frequency range of 1 to 105 Hz by a Solariton spectrometer and potentiostat. The RH was controlled by adjusting the ratio of dry and wet N₂ gas flow, and the internal RH of the membrane was monitored by humidity measurement. The membrane was equilibrated under a given RH for several hours prior to the impedance measurements. The resistance associated with the membrane at zero phase angle was used to estimate the proton conductivity of the membrane using the equation, σ=(1R) (L/A), where R is the bulk resistance of the membrane, L represents the membrane thickness, and A the membrane area. The thickness of the membranes varied from 178 to 195 microns.

Table 1 summarizes the water uptake in the fullerene composite membranes.

TABLE 1

| Water uptake | Recast Nafion ® | 1% C₆₀-Nafion ® | 3% PHF-Nafion ® |
|---|---|---|---|
| Wet | 23.87 | 27.96 | 26.62 |
| Dry | 3.71 | 5.89 | 7.96 |

The water retention in the composites was examined by TGA measurements in which the weight loss of the composites was monitored under the dry N₂ gas flow at 30° C. for 40 minutes, assuming the weight loss under this condition is primarily due to the water loss. Table 2 lists both water loss and the water remained in the membrane after subject to the dry N₂ gas flow for 40 minutes.

TABLE 2

| | Nafion ® | Recast | 1% C₆₀- | 1% PHF- | 3% PHF- |
|---|---|---|---|---|---|
| | 117 | Nafion ® | Nafion ® | Nafion ® | Nafion ® |
| Water loss | 12.4 | 6.58 | 9.79 | 8.04 | 3.66 |
| Water | 13.38 | 17.29 | 18.35 | 18.35 | 22.96 |
| remained | | | | | |

Both Tables 1 and 2 confirm that the fullerene increases water retention in the composite membranes. The increased water retention helps reduce the water diffusion in the membrane, thus reducing MeOH crossover.

The methanol crossover is expressed in terms of the limiting current density which is proportional to the MeOH diffusion, as Jₗᵢₘ=k*6*F*D*C/l where k is the coefficient, F the Faraday constant, D the MeOH diffusion constant, C the concentration of MeOH, and l the membrane thickness. Since the limiting current depends on the membrane thickness, the limiting current density is normalized to the thickness:

TABLE 3

| | Jₗᵢₘ, [mA cm⁻²] | (Jₗᵢₘ * thickness) [mA cm⁻¹] |
|---|---|---|
| 1 wt % C₆₀-Nafion ® | 44.2 | 0.051 |
| 1 wt % PHF-Nafion ® | 40.3 | 0.047 |
| 3 wt % PHF-Nafion ® | 40.0 | 0.044 |
| 1 wt % aminoC₆₀-Nafion ® | 39.7 | 0.042 |
| Recast Nafion ® | 48.3 | 0.052 |
| Nafion ® 117 | 37.0 | 0.068 |
| Nafion ® 115 | 54.1 | 0.068 |
| Nafion ® 112 | 125.0 | 0.069 |

It is clear that the fullerenes reduce the MeOH crossover of Nafion® with 3% inclusion of PHF achieving the lowest MeOH crossover, more than a 35% reduction, relative to a commercially available Nafion® membrane, in terms of the normalized measurements.

Table 4 summarizes the proton conductivity of various composites obtained from AC impedance measurements at 20° C. under 80% RH.

TABLE 4

| | | | | | | 1% amino- |
|---|---|---|---|---|---|---|
| | Nafion ® | Recast | 1% C₆₀- | 1% PHF- | 3% PHF- | fullerene- |
| | 117 | Nafion ® | Nafion ® | Nafion ® | Nafion ® | Nafion ® |
| σ, × 10⁻² S cm⁻¹ | 3 | 3.1 | 3.1 | 3.2 | 4.6 | 3.4 |

Thus, in contrast to many other attempts to reduce MeOH crossover, which result in lowered proton conductivity as well, the present invention reduces MeOH crossover while maintaining, and sometimes even enhancing, the conductivity.

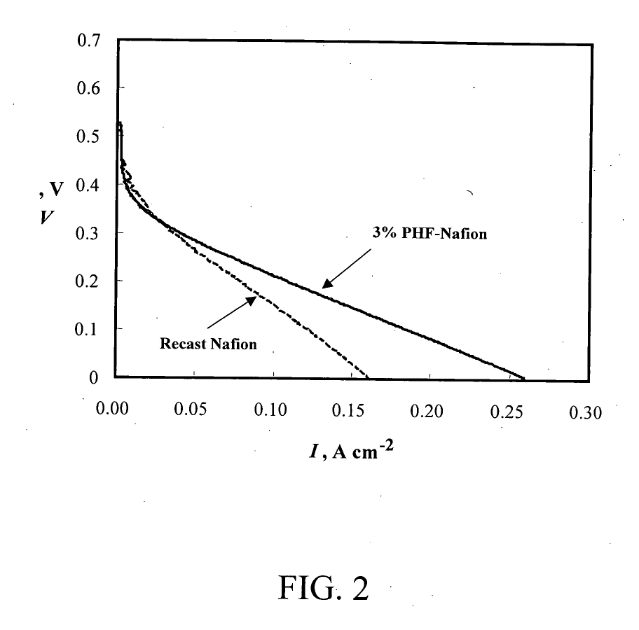

The polarization curves, as shown in FIG. 2, were measured for 3 wt % PHF-Nafion composite and the recast Nafion membrane. The MEAs were prepared in the same way as those for the MeOH crossover measurements, as mentioned above. Three membranes were used for the MEA: the recast Nafion, Nafion 115, and 3 wt % PHF-Nafion. The catalyst loading was 4 mg cm⁻² as Pt/Ru alloy for the anode and 0.5 mg cm⁻² as Pt for the cathode. The conditions for the polarization measurements were as follows: the anode fuel was 1M MeOH fed at 5 mL min⁻¹, while dry O₂ gas was fed into the cathode at 0.6 L min⁻¹. The operation temperature was 40° C. 3 wt % PHF-Nafion composite exhibits power densities of up to about 35 mW cm², which was 40% higher than that of the Nafion 115 and 100% higher than that of the recast Nafion.

While the present invention has been described with regards to particular embodiments, it is recognized that additional variations of the present invention may be devised without departing from the inventive concept.

### INDUSTRIAL APPLICABILITY

This invention can be used to provide electrolytic membranes for use in direct methanol fuel cells, and more particularly to provide cross-linked proton conducting membranes including water-binding fullerenes in such applications.

What is claimed is:

1. A proton conducting membrane for use in a direct methanol fuel cell, comprising:
(a) proton conducting polymer material; and
(b) polyhydroxy fullerene in a concentration of between about 1% and 5% by weight and having at least one multiple cross-linking functional group for blocking methanol crossover in the direct methanol fuel cell.

2. A proton conducting membrane as in claim 1 wherein the polyhydroxy fullerene has a chemical formula of C₆₀(OH)ₙ, where n is an integer within the range of about 2 to 48.

3. A proton conducting membrane as in claim 1 wherein the polyhydroxy fullerene has a chemical formula of C₆₀(OH)₁₂.

4. A proton conducting membrane for use in a direct methanol fuel cell, comprising:
(a) proton conducting polymer material; and
(b) fullerene with multiple cross-linking functional groups and in a concentration of between about 1% and 5% by weight for blocking methanol crossover in the direct methanol fuel cell.

5. A proton conducting membrane as in claim 4 wherein the cross-linking functional group comprises a base group.

6. A proton conducting membrane as in claim 4 wherein the fullerene comprises aminofullerene.

7. A proton conducting membrane for use in a direct methanol fuel cell, comprising:
(a) proton conducting polymer material; and
(b) aminofullerene with multiple cross-linking amino groups in a concentration of between about 1% and 5% by weight for blocking methanol crossover in the direct methanol fuel cell.

8. A proton conducting membrane for use in a direct methanol fuel cell, comprising:
(a) proton conducting polymer material; and
(b) water-binding fullerene derivatives for blocking methanol crossover in the direct methanol fuel cell.

9. A proton conducting membrane as in claim 8 wherein the concentration of the water-binding fullerene derivatives is between about 1 wt % and 20 wt %.

10. A proton conducting membrane as in claim 8 wherein the concentration of the water-binding fullerene derivatives is between about 1 wt % and 5 wt %.

11. A proton conducting membrane as in claim 8 wherein the concentration of the water-binding fullerene derivatives is between about 1 wt % and 3 wt %.

12. A proton conducting membrane as in claim 8 wherein the fullerene derivative comprises polyhydroxy fullerene having a chemical formula of C₆₀(OH)ₙ, where n is an integer within the range of about 2 to 48.

13. A proton conducting membrane as in claim 8 wherein the fullerene derivative comprises a polyhydroxy fullerene having a chemical formula of C₆₀(OH)₁₂.

14. A proton conducting membrane as in claim 8 wherein the fullerene derivative further comprises at least one multiple cross-linking functional group.

15. A proton conducting membrane as in claim 14 wherein the cross-linking functional group comprises a base group.

16. A proton conducting membrane as in claim 14 wherein the fullerene derivative comprises aminofullerene.

17. A proton conducting membrane as in claim 14 wherein the cross-linking functional group comprises a hydrogen acceptor site.

18. A proton conducting membrane as in claim 14 wherein the cross-linking functional group comprises an oxygen acceptor site.

19. A proton conducting membrane as in claim 14 wherein the cross-linking functional group comprises nitrogen, oxygen, and hydrogen.

20. A proton conducting membrane as in claim 8 wherein the fullerene derivative is mixed in the polymer material.

21. A proton conducting membrane as in claim 8 wherein the fullerene derivative is chemically attached to the polymer material.

22. A proton conducting membrane for use in a direct methanol fuel cell, comprising:
(a) proton conducting polymer material; and
(b) a polyhydroxy fullerene having a chemical formula of C₆₀(OH)₁₂ for blocking methanol crossover in the direct methanol fuel cell, wherein the concentration of the polyhydroxy fullerene is between about 1 wt % and 5 wt %, wherein the polyhydroxy fullerene further comprises at least one multiple cross-linking functional group having a hydrogen acceptor site, and wherein the polyhydroxy fullerene is chemically attached to the proton conducting polymer material.

23. A direct methanol fuel cell, comprising:
(a) an anode;
(b) a cathode;
(c) a proton conductive membrane separating the anode and the cathode, wherein the membrane comprises a solution cast of polymeric material and water-binding fullerene for blocking methanol crossover in the direct methanol fuel cell.

24. A direct methanol fuel cell as in claim 23 wherein the percent by weight of the water-binding fullerene is between about 1% and 5%.

25. A direct methanol fuel cell as in claim 23 wherein the percent by weight of the water-binding fullerene is between about 1% and 3%.

26. A direct methanol fuel cell as in claim 23 wherein the water-binding fullerene comprises a polyhydroxy fullerene having a chemical formula of C₆₀(OH)₁₂.

27. A direct methanol fuel cell as in claim 23 wherein the water-binding fullerene further comprises at least one base functional group.

28. A direct methanol fuel cell as in claim 23 wherein the water-binding fullerene comprises aminofullerene.

29. A direct methanol fuel cell as in claim 23 wherein the water-binding fullerene is mixed in the polymeric material.

30. A direct methanol fuel cell as in claim 23 wherein the water-binding fullerene is chemically attached to the polymeric material.

31. A direct methanol fuel cell, comprising:
(a) an anode;
(b) a cathode; and
(c) a proton conductive membrane separating the anode and the cathode, wherein the membrane comprises a solution cast of polymeric material and polyhydroxy fullerene, wherein the concentration of the polyhydroxy fullerene is between about 1 wt % and 5 wt %, wherein the polyhydroxy fullerene has a chemical formula of C₆₀(OH)₁₂, wherein the polyhydroxy fullerene further comprises at least one multiple cross-linking functional group, and wherein the polyhydroxy fullerene is chemically attached to the proton conducting polymeric material.

32. A fullerene-polymer composite, comprising:
(a) perfluoro polymer sulfonic acid; and
(b) a derivative of fullerene, wherein at least one functional group having a hydrogen acceptor or a hydrogen donor is attached to the fullerene.

33. A fullerene-polymer composite as in claim 32 wherein the derivative of fullerene is between about 1% and 20% by weight of the composite.

34. A fullerene-polymer composite as in claim 32 wherein the derivative of fullerene comprises a polyhydroxy fullerene having a chemical formula of between C₆₀(OH)₂ and C₆₀(OH)₄₈.

35. A fullerene-polymer composite as in claim 32 wherein the functional group is cross-linked to at least one sulfonic group.

36. A fullerene-polymer composite, comprising:
(a) perfluoro polymer sulfonic acid; and
(b) polyhydroxy fullerene having a chemical formula of between C₆₀(OH)₂ and C₆₀(OH)₄₈, wherein at least one functional group having a hydrogen acceptor or a hydrogen donor is attached to the fullerene, wherein the functional group is cross-linked to at least one sulfonic group, and wherein the polyhydroxy fullerene is between about 1% and 20% by weight of the composite.

37. A fullerene-copolymer composite, comprising:
(a) a copolymer of tetrafluoroethylene and perfluoro-3,6-dioxa-4-methyl-7-octenesulfonyl fluoride; and
(b) a derivative of fullerene, wherein at least one functional group having a hydrogen acceptor or a hydrogen donor is attached to the fullerene.

38. A fullerene-copolymer composite as in claim 37 wherein the derivative of fullerene is between about 1% and 20% by weight of the composite.

39. A fullerene-copolymer composite as in claim 37 wherein the derivative of fullerene is between about 1% and 5% by weight of the composite.

40. A fullerene-copolymer composite as in claim 37 wherein the derivative of fullerene is between about 1% and 3% by weight of the composite.

41. A fullerene-copolymer composite as in claim 37 wherein the derivative of fullerene comprises a polyhydroxy fullerene.

42. A fullerene-copolymer composite as in claim 37 wherein the derivative of fullerene comprises a polyhydroxy fullerene having a chemical formula of between C₆₀(OH)₂ and C₆₀(OH)₄₈.

43. A fullerene-copolymer composite as in claim 37 wherein the functional group comprises at least one base group.

44. A fullerene-copolymer composite as in claim 37 wherein the derivative of fullerene comprises aminofullerene.

45. A fullerene-copolymer composite as in claim 37 wherein the derivative of fullerene is solution cast with the copolymer.

46. A fullerene-copolymer composite as in claim 37 wherein the derivative of fullerene is chemically bonded to the copolymer.

47. A fullerene-copolymer composite, comprising:
(a) a copolymer of tetrafluoroethylene and perfluoro-3,6-dioxa-4-methyl-7-octenesulfonyl fluoride; and
(b) fullerene derivative having at least one functional group having a hydrogen donor, wherein the functional group is a base group and the fullerene derivative is between about 1% and 5% by weight of the composite, and wherein the functional group is cross-linked to at least one sulfonic group.

48. A method of blocking methanol crossover in direct methanol fuel cells, comprising the steps of:
(a) mixing a predetermined amount of water-binding fullerene derivatives with a polymer material to produce a membrane;
(b) separating an anode and a cathode with the membrane; and
(c) operating the anode and cathode as a direct methanol fuel cell wherein the membrane promotes proton conductivity while reducing methanol crossover.

49. The method of claim 48 wherein the step of mixing the polymer material and the water-binding fullerenes comprises solution casting the polymer material and the water-binding fullerenes.

50. The method of claim 48 wherein the water-binding fullerenes are chemically attached to the polymer material.

51. The method of claim 48 wherein the water-binding fullerenes comprises at least one base group.

52. The method of claim 48 wherein the water-binding fullerenes comprise a polyhydroxy fullerene having a chemical formula of C₆₀(OH)₁₂.

53. A method of blocking methanol crossover in direct methanol fuel cells, comprising the steps of:
(a) solution casting a predetermined amount of an aminofullerene at least one multiple cross-linking functional group.
(b) separating an anode and a cathode with the membrane; and
(c) operating the anode and cathode as a direct methanol fuel cell wherein the membrane promotes proton conductivity while reducing methanol crossover.
